(19) United States
(12) Patent Application Publication
(10) Pub. No.: US 2026/0172489 A1
(43) Pub. Date: Jun. 18, 2026

(54) APPARATUS FOR CONTROLLING A VEHICLE AND A METHOD THEREOF

(71) Applicants: HYUNDAI MOTOR COMPANY, Seoul (KR); KIA CORPORATION, Seoul (KR)

(72) Inventors: Jin Young Lee, Hwaseong-si (KR); Kyung Bok Lee, Hwaseong-si (KR); Moon Shik Choi, Hwaseong-si (KR)

(73) Assignees: HYUNDAI MOTOR COMPANY, Seoul (KR); KIA CORPORATION, Seoul (KR)

(21) Appl. No.: 19/227,996

(22) Filed: Jun. 4, 2025

(30) Foreign Application Priority Data
Dec. 16, 2024 (KR) 10-2024-0187738

(51) Int. Cl. H04L 69/08; H04L 12/66; H04L 67/12

(52) U.S. Cl. CPC H04L 69/08; H04L 12/66; H04L 67/12

(57) ABSTRACT

A vehicle control apparatus may include a processor configured to receive communication protocol data within a vehicle, convert the communication protocol data within the vehicle into service interface protocol data, and transmit the service interface protocol data to an external vehicle system. The processor may be configured to implement a service-oriented architecture (SOA) adaptor configured to convert the communication protocol data within the vehicle into the service interface protocol data and an SOA gateway configured to transmit the service interface protocol data converted from the SOA adaptor to an external vehicle cloud network system as a piece of middleware.

### CROSS-REFERENCE TO RELATED APPLICATION

This application claims the benefit of and priority to Korean Patent Application No. 10-2024-0187738, filed on Dec. 16, 2024, the entire contents of which are hereby incorporated herein by reference.

### TECHNICAL FIELD

The present disclosure relates to a vehicle control apparatus and a method thereof, and more specifically, relates to a technology for efficiently transmitting and receiving data between an internal system of a vehicle and an external system.

### BACKGROUND

Intelligent Transportation System (ITS) refers to an integrated transportation system that optimizes the interaction between transportation infrastructure, vehicles, roads, and users by using advanced information and communication technology (ICT) to improve safety, efficiency, and convenience. Nowadays, with the development of wireless communication systems, for example, services for smart cities and smart cars are embodied based on 3G, 4G, and 5G communication technologies and IoT-related technologies. Moreover, Ultra-high-speed communication, low latency, and mass data transmission are supported by using 5G-Adv, 6G and next-generation communication technologies and IoT security, edge computing/network slicing, low power wide area (LPWA), and the like, and communication between vehicles and external entities such as other vehicles and infrastructure is also becoming widespread.

A vehicle includes a communication control unit (CCU) to exchange or share communication information with the outside. While communicating with another vehicle in real time through the CCU and exchanging driving information with other vehicles, the vehicle may predict collision accidents and road conditions more efficiently. For example, vehicle-to-everything (V2X) refers to a communication method of exchanging or sharing information such as traffic conditions while a vehicle communicates with road infrastructure and other vehicles while driving, and is developing into a technology that allows all elements (vehicle to vehicle, vehicle to infrastructure, vehicle to pedestrian, vehicle to network, and the like) of a road to exchange information in real time.

Accordingly, the number of electronic control units (ECU) installed in vehicles continues to increase significantly to support various services.

### SUMMARY

The present disclosure was made to solve the above-mentioned problems occurring in the prior art while advantages achieved by the prior art are maintained intact.

Aspects of the present disclosure provide a vehicle control apparatus and a method for efficiently transmitting and receiving data between vehicle internal and external systems.

Aspect of the present disclosure provide a vehicle control apparatus and a method for supporting services based on service-oriented architecture (SOA).

Aspects of the present disclosure provide a vehicle control apparatus and a method for ensuring data interoperability between heterogeneous systems.

Aspects of the present disclosure provide a vehicle control apparatus and a method for ensuring efficiency in service provision by processing real-time data.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle control apparatus is provided. The vehicle control apparatus includes a processor configured to receive communication protocol data within a vehicle, convert the communication protocol data within the vehicle into service interface protocol data, and transmit the service interface protocol data to an external vehicle system. The processor is configured to implement, as a piece of middleware, a service-oriented architecture (SOA) adaptor configured to convert the communication protocol data within the vehicle into the service interface protocol data and a SOA gateway configured to transmit the service interface protocol data converted from the SOA adaptor to an external vehicle cloud network system.

In an embodiment, the processor may be configured to use controller area network (CAN) communication as a protocol within the vehicle.

In an embodiment, the protocol within the vehicle may further include at least one of Ethernet (Automotive Ethernet) communication, local interconnect network (LIN) communication, FlexRay communication, vehicle signal specification (VSS) communication, or data distribution service (DDS) communication.

In an embodiment, the SOA adaptor may be configured to receive CAN data in the vehicle in real time and convert the CAN data into a JavaScript Object Notation (JSON) configuration file. The SOA adaptor may be configured to perform communication in units of service defined for an SOA service.

In an embodiment, the SOA adaptor may be configured to identify the CAN data, perform a consistency check on the CAN data, may map the CAN data into service interface protocol data including a field, an event, and an operation, based on the determining that the CAN data passes the consistency check.

In an embodiment, the SOA gateway may be configured to convert a JSON configuration file received from the SOA adaptor into a message queuing telemetry transport (MQTT) protocol message and transmit the MQTT protocol message to the external vehicle cloud network system.

In an embodiment, the SOA gateway may be configured to identify service interface protocol data received from the SOA adaptor, perform a consistency check on the service interface protocol data, and transmit an SOA gateway route report message to the external vehicle cloud network system based on determining that the service interface protocol data passes the consistency check.

In an embodiment, the SOA gateway may be configured to determine whether an acknowledgment (ACK) for the SOA gateway route report message is received from the external vehicle cloud network system and re-transmit the SOA gateway route report message based on determining that the acknowledgment (ACK) is not received from the external vehicle cloud network system.

In an embodiment, the SOA gateway may be configured to determine that CAN data within the vehicle is normally received from the external vehicle cloud network system based on determining that the acknowledgement (ACK) is received from the external cloud network system.

In an embodiment, the SOA gateway may be configured to receive an SOA gateway route request message including a value for triggering CAN data within the vehicle from the external vehicle cloud network system, perform a consistency check on the SOA gateway route request message, check service availability of a service corresponding to a corresponding message in response to determining that the SOA gateway route request message passes the consistency check, and perform an operation call to the SOA adaptor based on determining that the service is available. The SOA adaptor may be configured to identify the operation call and transmit the CAN data to a triggered controller corresponding to the operation call. The SOA gateway may communicate with the external vehicle cloud network system through at least one of a scalable service-oriented middleware over IP (SOME/IP) protocol, an automotive application programming interface (API), or a DDS protocol. The SOA adaptor may perform communication through at least one of Ethernet (Automotive Ethernet) communication, LIN communication, FlexRay communication, VSS communication, or DDS communication.

According to another aspect of the present disclosure, a vehicle control method is provided. The vehicle control method includes receiving communication protocol data within a vehicle, converting, by a service-oriented architecture (SOA) adaptor, the communication protocol data within the vehicle into service interface protocol data, and transmitting, by an SOA gateway, the service interface protocol data to an external vehicle system. The SOA adaptor and the SOA are implemented as a piece of middleware.

In an embodiment, receiving the communication protocol data within the vehicle may include receiving the communication protocol data using CAN communication.

In an embodiment, receiving the communication protocol data within the vehicle may include receiving the communication protocol data using at least one communication of Ethernet (Automotive Ethernet) communication, LIN communication, FlexRay communication, VSS communication, or DDS communication, as the receiving of the communication protocol data within the vehicle.

In an embodiment, the vehicle control method may further include converting the CAN data into a JSON configuration file, and performing communication in units of service defined for an SOA service.

In an embodiment, the vehicle control method may include identifying the CAN data, performing a consistency check on the CAN data, and mapping the CAN data into service interface protocol data including a field, an event, and an operation, in response to determining that the CAN data passes the consistency check.

In an embodiment, the vehicle control method may include converting the received JSON configuration file into a MQTT protocol message, and transmitting the MQTT protocol message to the external vehicle system.

In an embodiment, the method may include identifying the service interface protocol data, performing a consistency check on the service interface protocol data, and transmitting an SOA gateway route report (message to the external vehicle system in response to determining that the service interface protocol data passes the consistency check.

In an embodiment, the vehicle control method may include determining whether an acknowledgment (ACK) for the SOA gateway route report (SOA GWY Route Report) message is received from the external vehicle system, and re-transmitting the SOA gateway route report message in response to determining that the acknowledgment (ACK) is not received from the external vehicle system.

In an embodiment, the vehicle control method may include determining that CAN data within the vehicle is normally received from the external network system in response to determining that the acknowledgment (ACK) is received from the external vehicle system.

In an embodiment, the vehicle control method may include receiving, by the SOA gateway, an SOA gateway route request message including a value for triggering CAN data within the vehicle from the external vehicle system, performing a consistency check on the SOA gateway route request message, checking service availability of a service corresponding to a corresponding message in response to determining that the SOA gateway route request message passes the consistency check, and performing am operation call based on determining that the service is available. The method may also include identifying, by the SOA adaptor, the operation call, and transmitting the CAN data to a triggered controller corresponding to the identified method call. The method may further include communicating, by the SOA gateway, with the external vehicle cloud network system through at least one of a SOME/IP protocol, an automotive API, or a DDS protocol. The method may further include performing, by the SOA adaptor, communication through at least one of Ethernet (Automotive Ethernet) communication, LIN communication, FlexRay communication, VSS communication, or DDS communication.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a configuration of a vehicle system including a vehicle control apparatus, according to an implementation of the present disclosure;

FIG. 2 is a diagram schematically illustrating a block diagram of a system that efficiently controls network connections, according to an implementation of the present disclosure;

FIG. 3 is a block diagram showing a configuration of a vehicle control apparatus supporting an SOA system, according to an implementation of the present disclosure;

FIG. 4 is a conceptual diagram illustrating a configuration for processing data based on SOA inside a vehicle and outside a vehicle, according to an implementation of the present disclosure;

FIG. 5 is a conceptual diagram showing a configuration of data conversion and management based on SOA in a vehicle control apparatus, according to an implementation of the present disclosure;

FIG. 6 is a conceptual diagram for describing a process of converting and managing data in a vehicle control apparatus, according to an implementation of the present disclosure;

FIG. 7 is a conceptual diagram for describing a process of converting and managing data in a vehicle control apparatus, according to another implementation of the present disclosure; and

FIG. 8 illustrates a computing system according to an implementation of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the accompanying drawings. In adding reference numerals to components of each drawing, it should be noted that the same components are designated by the same reference numerals, even when the components are illustrated on different drawings. Furthermore, in describing the embodiments of the present disclosure, where it was determined that a detailed descriptions of well-known functions or configurations would unnecessarily obscure the gist of the present disclosure, the detailed description thereof has been omitted.

In describing elements of an embodiment of the present disclosure, the terms first, second, A, B, (a), (b), and the like may be used herein. These terms are only used to distinguish one element from another element. These terms do not limit the corresponding elements irrespective of the nature, order, or priority of the corresponding elements. Furthermore, unless otherwise defined, all terms used herein, including technical or scientific terms, include the same meaning as commonly understood by one of ordinary skill in the art to which the present disclosure pertains. It should be understood that terms used herein should be interpreted as including a meaning that is consistent with their meaning in the context of the present disclosure and the relevant art. The terms should not be interpreted in an idealized or overly formal sense unless expressly so defined herein.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, gateway, server, and the like may separately embody or be included with a processor and a memory, such as a non-transitory computer readable media, as part of the apparatus.

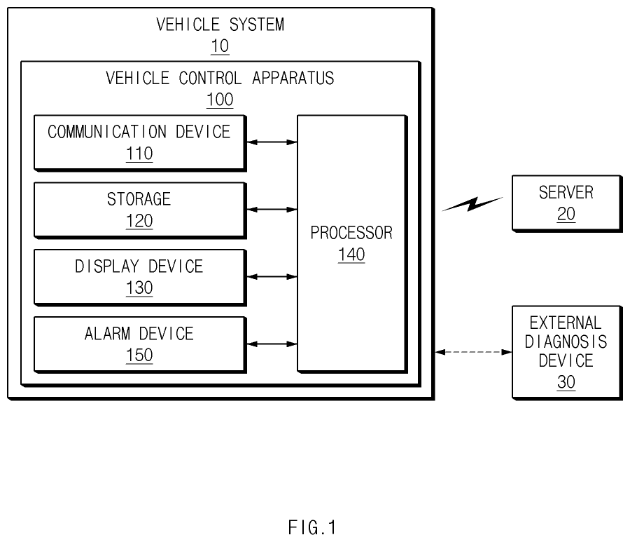

Hereinafter, embodiments of the present disclosure are described in detail with reference to FIGS. 1-8.

FIG. 1 is a block diagram illustrating a configuration of a vehicle system 10 including a vehicle control apparatus 100, according to an embodiment of the present disclosure.

Referring to FIG. 1, the vehicle control apparatus 100 according to an embodiment of the present disclosure may be provided inside a vehicle. For example, the vehicle control apparatus 100 may be integrated with internal control units of the vehicle and/or may be implemented with a separate device so as to be coupled with control units of the vehicle by means of a separate connection means. As an example, the vehicle control apparatus 100 may include a transmission control apparatus that comprehensively manages and controls various subsystems (a transmission, an engine, a brake, etc.) of a vehicle. Moreover, the vehicle control apparatus 100 may include a service device that supports a service based on service-oriented architecture (SOA). The vehicle control apparatus 100 according to an embodiment of the present disclosure may provide a service device or module that supports a smart service by processing and analyzing vehicle data in real time by using an external network and an analysis system. The service device or module may be formed as an integrated device or may be implemented as a separate device so as to be connected to control units of the vehicle.

According to an embodiment of the present disclosure, the vehicle control apparatus 100 may include a communication device 110, storage 120, a display device 130, a processor 140, and an alarm device 150.

The communication device 110 may be a hardware device implemented with various electronic circuits for transmitting and receiving signals over a wireless or wired connection. According to an embodiment of the present disclosure, the communication device 110 may perform communication in the vehicle through Controller Area Network (CAN) communication, CAN-FD communication, LIN communication, Ethernet communication or Automotive Ethernet communication, and the like. Communication within the vehicle may also be performed through FlexRay communication and/or Data Distribution Service (DDS) communication. The communication device 110 may include various communication units such as a mobile communication unit for communication with a server 20 and an external diagnosis device 30 outside the vehicle, a broadcast receiving unit such as a DMB module or a DVB-H module, a short range communication unit such as a Zigbee module being a Bluetooth module or an NEC module, a Wi-Fi communication unit, and/or the like. For example, the CAN communication is a vehicle network system developed to provide digital serial communication between various measurement and control devices in a vehicle. In an embodiment, a CAN-data bus may be used to transmit and control data between electronic control units (ECUs) in the vehicle. Furthermore, the communication device 110 according to an embodiment of the present disclosure may perform bidirectional communication with surrounding vehicles, between a vehicle and a surrounding vehicle, between a vehicle and a road infrastructure, and between a vehicle and a pedestrian, etc. The communication device 110 may continuously share and send/receive data with all elements including the host vehicle and surrounding vehicles. The communication device 110 may be implemented to be mounted on the vehicle itself or to be in contact with a communication terminal. In this way, it is possible to perform communication between vehicles and infrastructure communication between vehicles, and it is possible to autonomously drive to the specified destination through a one or more vehicle sensors and a driving control function provided in the vehicle. The one or more vehicle sensors may include at least one of a global positioning system (GPS) sensor, a gyro sensor, or an acceleration sensor. The GPS sensor, the gyroscope sensor, and/or the acceleration sensor may measure a vehicle's location, movement, and attitude, and may be coupled with other sensors in a vehicle to support driving safety, autonomous driving, navigation system, and vehicle tracking and management. For example, the gyro sensor and the acceleration sensor may be coupled with LiDAR, cameras, and RADAR to monitor the vehicle's position and attitude in real time, and the vehicle's rotation and acceleration may be controlled while the gyro sensor and the acceleration sensor are coupled with each other. Further, precise path tracking and real-time driving control for autonomous vehicles may be performed by tracking a location through the GPS sensor, maintaining a direction by using the gyroscope sensor, and detecting movement changes by using the acceleration sensor. Moreover, environmental sensors that recognize external environments may include LiDAR generating 3D terrain data around a vehicle by using lasers, RADAR measuring the distance and speed of the vehicle by using radio waves, ultrasonic sensors detecting objects at a short distance (e.g., parking assistance systems), and camera sensors maintaining lanes, recognizing road signs, and detecting pedestrians. In various embodiments, various sensor fusion technologies may be applied.

The communication device 110 may support WAVE communication technology for V2X communication function and/or may support communication technology including 3GPP-based LTE, NR, 5G-Adv, and/or 6G systems. For example, when a new radio (NR) access technology of 5G system is supported, the NR access technology may support enhanced mobile broadband (eMBB), massive machine type communications (mMTC), or ultra-reliable and low-latency communications (URLLC). The wireless communication module may support a high frequency band (e.g., mmWave band) to achieve a high data transfer rate. The wireless communication module may support various technologies to be applied to secure performance in a high frequency band, for example, beamforming, massive multiple-input and multiple-output (massive MIMO), full dimensional MIMO (FD-MIMO), an array antenna, analog beam-forming, and/or a large scale antenna. Furthermore, with the advancement of next-generation communication technologies, a wireless communication module capable of performing signal processing tasks such as channel estimation, equalization, and de-mapping may be supported by utilizing newly proposed new types of AL/ML models. As such, service optimization and data, channel estimation, or the like may be applied through an efficient network air interface. As an example, in an embodiment of the present disclosure, when the communication device 110 supports wireless access for vehicle environment (WAVE) communication, the communication device 110 may support IEEE 802.11a wireless LAN technology for smooth communication of vehicle-to-vehicle (V2V) and vehicle-to-infrastructure (V2I). Accordingly, a channel bandwidth of 10 MHz may be used in a band of 5.9 GHz, the data rate of up to 27 Mbps may be supported, CSMA/CA may be supported in a wireless channel access scheme, a physical layer may be based on IEEE 802.11p, and an upper layer may use the IEEE 1609.x standard.

Moreover, when the 3GPP system is supported, the communication device 110 according to an embodiment of the present disclosure may support LTE eV2X, 5G/5G-Adv, and 6G NR V2X communication technologies based on LTE V2X (Rel. 14). In general, the V2X communication includes vehicle-to-vehicle (V2V) indicating LTE/NR-based communication between vehicles, vehicle-to-pedestrian (V2P) indicating LTE/NR-based communication between vehicles and terminals carried by individuals, and vehicle-to-infrastructure/network (V2I/N) indicating LTE/NR-based communication between vehicles and roadside units/networks. Accordingly, network scalability may be improved in V2I communication by using OFDMA wireless access. Furthermore, 5G NR, 5G-Adv, 6G, and next-generation communication systems may support enhanced V2X services such as sharing sensor data of autonomous vehicles for ultra-low latency and high-reliability communication and updating high-precision map, and may consider coexistence and interoperability with existing LTE V2X. Accordingly, a safe and efficient transportation system may be supported by improving the reliability, delay time, and throughput of vehicle communication. Also, there is no limitation on the multiple access technique of a wireless communication system to which the present disclosure is applied. For example, various multiple access techniques such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, and/or OFDM-CDMA may be used. Moreover, uplink and downlink transmissions may use either a time division duplex (TDD) scheme of sending data by using different times, or a frequency division duplex (FDD) scheme of sending data by using different frequencies.

The storage 120 may download and store various service data for the corresponding vehicle received from the server 20 through the communication device 110, and data for vehicle wireless updates. Accordingly, the storage 120 may identify and store/manage/update pieces of information about a road environment and road surrounding information such as location information of a host vehicle, road information, bus station information, etc. that are collected through vehicle sensors provided in a vehicle and the server 20. Moreover, the storage 120 may receive and store destination information set by a user, existing found routes, and infrastructure information related to outside and traffic, that may be updated in real time, depending on a predetermined cycle or predetermined service. Furthermore, according to an embodiment of the present disclosure, data for various input sensors for supporting autonomous driving, and data obtained through a server that supports road information and communication information may be stored/managed. Road information and traffic information, obtained by receiving pieces of communication system information through a communication server, and pieces of data input through various sensors installed inside/outside the vehicle may be stored/managed/updated.

The storage 120 may include at least one type of a storage medium among a flash memory type of a memory, a hard disk type of a memory, a micro type of a memory, or a card type (e.g., a Secure Digital (SD) card or an eXtream Digital (XD) card) of a memory, a random access memory (RAM) type of a memory, a static RAM (SRAM) type of a memory, a read-only memory (ROM) type of a memory, a programmable ROM (PROM) type of a memory, an electrically erasable PROM (EEPROM) type of a memory, a magnetic RAM (MRAM) type of a memory, a magnetic disk type of a memory, or an optical disc type of a memory.

The display device 130 may be controlled by the processor 140 to display a screen for receiving the approval of user authentication for the wireless update of a vehicle. The display device 130 may be implemented with a head-up display (HUD), a cluster, or an audio video navigation (AVN). Furthermore, the display device 130 may include at least one of a Liquid Crystal Display (LCD), a Thin Film Transistor-LCD (TFT LCD), a Light Emitting Diode (LED) display, an Organic LED (OLED) display, an Active Matrix OLED (AMOLED) display, a flexible display, a bended display, or a 3D display. Some of the displays may be implemented with a transparent display that is transparent or translucent to view the outside. Moreover, the display device 130 may be provided as a touchscreen including a touch panel and may be used as an input device in addition to an output device.

The processor 140 may be electrically connected to the communication device 110, the storage 120, the display device 130, the alarm device 150, and the like, and may electrically control each of the components. The processor 140 may be an electrical circuit that executes the instructions of the software, and may perform various data processing and calculation described below. The processor 140 may support adaptive data processing and calculation by applying a newly proposed new type of AL/ML model or considering an internally implemented AL/ML model.

When a screen for receiving approval from a user is displayed on the display device 130, the alarm device 150 may output a notification for approval to the user. In an embodiment, the alarm device 150 may provide various pieces of information for V2X services such as driving guidance, traffic safety, or the like such as resetting the route for the degree of congestion, the alarm of the degree of congestion, or the like as well as infotainment information within a vehicle.

The vehicle according to an embodiment of the present disclosure may be equipped with a plurality of electronic control apparatuses (ECUs) that are connected to internal/external communication, thereby increasing user safety and providing various convenient functions. The ECU may be a module that performs various electronic control functions within the vehicle, and may include, for example, an engine control module (ECM) that is responsible for optimizing and controlling engine performance, a transmission control module (TCM) that is responsible for managing the transmission, a brake module (BCM) that manages and controls a brake system, an airbag control unit (ACU) that controls the operation and management of an airbag, and a body control module (BCM) that manages and controls body-related functions such as door locks and interior lighting of the vehicle.

In an embodiment, a controller area network (CAN) data bus may support communication between ECUs in the vehicle. In this way, the ECUs may exchange sensor data and commands in real time with each other and may comprehensively control various functions of the vehicle. Moreover, FlexRay may be applied as a communication protocol for vehicles. The FlexRay may support data transmission rates of up to 10 Mbps and may implement redundancy or increase data transfer amount through two independent communication channels. Moreover, the FlexRay may apply a time slot concept such that all nodes on a network are capable of transmitting data without collision by using a TDMA scheme, and may support ADAS and autonomous driving by sharing data necessary to determine autonomous driving between ECUs. For example, data generated inside a vehicle through the FlexRay may be transmitted to other vehicles or infrastructure through a 3GPP-based communication network.

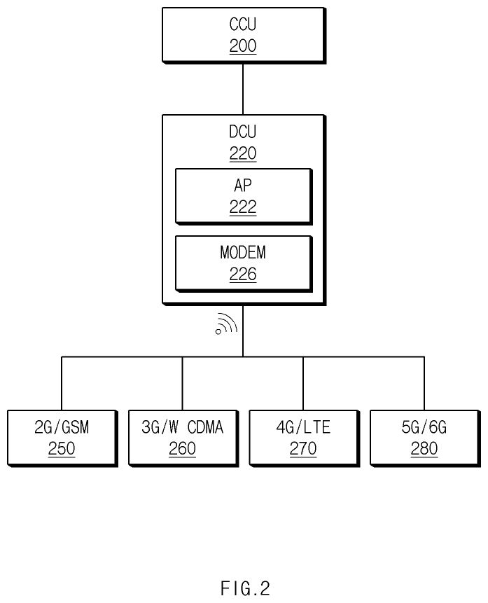

FIG. 2 is a schematic diagram of a vehicle communication control system that efficiently controls wireless network connections to reduce power consumption, according to an embodiment of the present disclosure.

Referring to FIG. 2, a communication control module (CCU) 200 may be a communication control device of a vehicle and may include a central control apparatus that manages data communication between the vehicle's internal and external networks. Moreover, the CCU 200 may provide connections between various ECUs and systems within the vehicle, as well as connections with external servers or cloud services. The CCU 200 according to an embodiment of the present disclosure may support V2X communication (e.g., data exchange between vehicles (V2V), between vehicles and infrastructure (V2I)), connected services (e.g., real-time navigation, remote diagnosis, over-the-air (OTA) update support), data gateway (e.g., a bridge role between protocols such as CAN or LIN inside a vehicle and LTE, 5G/5G-Adv, and 6G communication outside the vehicle), and security management (e.g., data encryption and intrusion detection in a vehicle communication channel).

A domain control unit (DCU) 220 may be a control device that controls and manages a specific domain (functional area) of a vehicle, and may efficiently control each domain (e.g., powertrain, body, infotainment, or the like) by integrating a plurality of distributed ECUs. For example, when ECU integration is supported, the system complexity is reduced by integrating roles of a plurality of ECUs, thereby reducing system operating costs. Furthermore, when real-time data is processed, fast and accurate data processing may be supported, which may enhance autonomous driving and vehicle control functions. For example, When a modular design scheme is applied, independent management for each domain becomes possible, thereby making maintenance easier. Also, high-performance computation and optimization may be supported through smart control in the main domain (e.g., a framework or an electrical system) of a vehicle. For example, the DCU 220 may manage the vehicle's electric drive system to maximize battery efficiency, or to manage an infotainment system, thereby improving user experience.

The CCU 200, according to an embodiment of the present disclosure, may transmit and receive data through communication with the outside in an ignition (IGN) On state (e.g., a state where a vehicle's electrical system is activated, such as a state where an engine is ready to operate, a state where power is supplied to an electronic device, or a state where an ignition switch is turned on). The DCU 220 may perform main control on a vehicle domain in the IGN On state. On the other hand, in the IGN Off state (e.g., a state where all of an electrical system and an engine of a vehicle are deactivated, such as a state where the engine is turned off, and a state where an ignition switch is turned off), the CCU 200 and the DCU 220 may enter a low power mode to minimize battery usage and may operate only for basic maintenance functions. In an embodiment of the present disclosure, the CCU 200 and the DCU 220 are described as a separate unit, but the CCU 200 and the DCU 220 may be integrated within a vehicle and may operate in the IGN state, thereby maximizing the efficiency and performance of the vehicle.

According to an embodiment of the present disclosure, when the vehicle completes parking and IGN is turned off, the vehicle enters a sleep mode. This may correspond to a sleep mode of an application (AP) area 222 of the DCU 220, and may allow a modem area 226 to operate in an on state. In an embodiment, a modem-on state indicates that the corresponding vehicle is normally registered in a network, and includes a state where a connection is maintained to a next-generation communication wireless network system depending on surrounding network environments, by including a GSM 250, a WCDMA 260, an LTE 270, and an NR/5G-Adv/6G 280. This means that the modem may continuously use SMS/Call/Data and user CCS service, or vehicle-specific services of a cloud server. Accordingly, when a mobile termination (MT) short message service (SMS) arrives, the DCU modem 226 may identify the corresponding message. When the message is a valid message, the DCU modem 226 may transition the CCU 200 to be in a wake up state, and may allow the CCU 200 to use connected car service (CCS). Moreover, when the corresponding CCS service is terminated, the CCU 200 may enter a sleep state, and the DCU modem 226 may be controlled to remain in an on state while low power is maintained.

According to an embodiment of the present disclosure, an SOA-based system that satisfies the complexity and flexibility of a vehicle communication system by exchanging data using various technologies and protocols is provided. Application communication based on scalable service-oriented middleware over IP (SOME/IP) protocol may be used to exchange data between applications in a vehicle in an IP-based network (e.g., Ethernet), and in particular, may play an important role in communication between distributed ECUs in a vehicle according to a middleware protocol designed to implement SOA in vehicle networks.

For SOME/IP-based service communication, a service interface is defined between applications, and communication is performed based on the service interface. A header file (.hpp) and a source file (.cpp) are generated based on an interface description language (IDL) file according to the SOME/IP service. For example, when a datatype or a data transmission scheme is changed, a service interface needs to be redefined, and the header file (.hpp)/source file (.cpp) needs to be extracted through a code generation (Code gen) task. Application developers need to update software logic again with the header file and the source file included, and may then proceed to the software (SW) build and controller integration build, thereby enabling new communication. The header file (.hpp) includes definitions of services and methods, and provides data structures and interfaces for methods and events. The source file (.cpp) includes the implementation of the services and methods, and includes writing request/response and event handlers.

Accordingly, when SW build and controller integration build are in progress, the generated header file (.hpp) and source file (.cpp) files may be included in a project's build system (CMake, Makefile, or the like). Thus, a client may call a service while a MyService. hpp file is included, and a server may implement method logic in the MyService. cpp file to support the service. Accordingly, as applications are developed while libraries are directly included according to SOME/IP services, an in-vehicle area and an out-vehicle area may include overall coverage from inside to outside of the vehicle through the application development of an SOA adaptor and the application development of an SOA gateway, respectively.

However, to perform new datatype or new service communication, as described above, a complicated procedure is required from interface definition to software logic update and controller integration build. Further, when a simple communication method is changed or a critical issue is found in a development stage, it is difficult to respond flexibly because application SW build and controller level integration build processes are required. In view of these situations, an embodiment of the present disclosure provides an SOA adaptor that converts CAN communication developed to directly include SOME/IP libraries into a service, and provides an SOA gateway that converts data generated by an in-vehicle communication system (e.g., CAN, FlexRay, or the like) into a message queuing telemetry transport (MQTT) protocol and supports communication with an external system (e.g., a cloud platform or an IoT device), thereby transmitting a new CAN signal inside a vehicle to the outside of the vehicle or controlling the new CAN signal by the outside of the vehicle. Accordingly, data may be efficiently managed based on the concept of SOA without the separate SW update and controller integration build processes, and the communication with the inside and outside of the vehicle may be facilitated. Furthermore, the SOA adaptor and SOA gateway according to an embodiment of the present disclosure may also communicate with other SOME/IP-based applications.

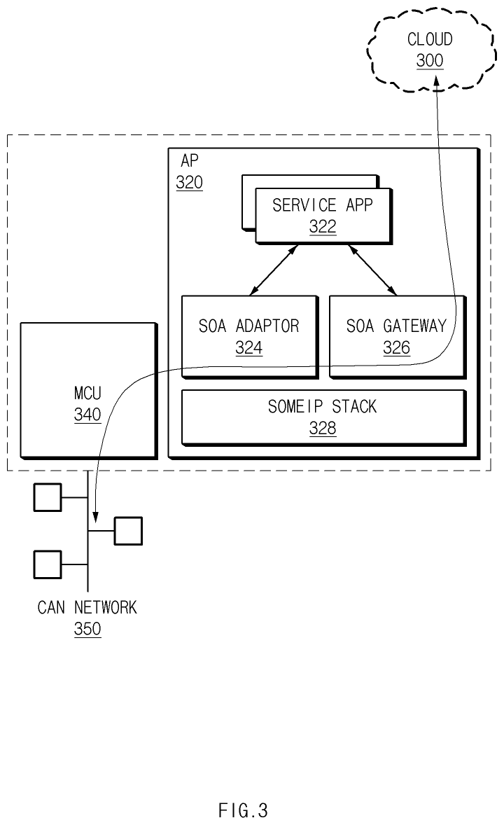

FIG. 3 is a block diagram showing a configuration of a vehicle control apparatus supporting an SOA system, according to an embodiment of the present disclosure.

Referring to FIG. 3, when a CAN signal 350 inside a vehicle is transmitted to a cloud 300 outside the vehicle, when the CAN signal 350 inside the vehicle is controlled by the cloud 300 outside the vehicle, and/or when a new API (e.g., weather information, etc.) outside the vehicle is utilized by an application 320 inside the vehicle, an SOA adaptor 324 converts the CAN signal into a service interface format. As such, when a new CAN signal is added, the SOA adaptor 324 may transmit the new CAN signal in the service interface format based on a configuration file in JSON format without build and without updating software logic. In an embodiment, the SOA adaptor 324 may perform the collection, conversion, routing, and security of vehicle data based on a JSON configuration file, and may simplify a SW build or update procedure by managing data flow based on an SOA model, thereby simplifying the development of an application.

An SOA gateway 326 may be a module that converts service interface information into MQTT and transmits the MQTT to a cloud, and/or allows the cloud outside the vehicle to obtain service information inside the vehicle in the service interface format. Moreover, the SOA gateway 326 may be a module that transmits an API outside the vehicle to an application inside the vehicle in the service interface format. Thus, a service application 322 inside the vehicle may obtain an external API (e.g., weather information, etc.) in the service interface format through the SOA gateway 326. In an embodiment, when the SOA adaptor 324 and the SOA gateway 326 are connected with each other, the CAN signal from inside the vehicle may be transmitted to the outside of the vehicle through a configuration file in JSON format without changing the service interface. This may be done without a software update process, thereby bypassing the SW build and controller integration build process.

In an example, the SOA adaptor 324 may include data sources, data conversion rules, data transmission, destination, communication protocol, security, and authentication to be processed through a JSON file. The SOA gateway 326 may convert and manage data generated inside the vehicle into MQTT so as to communicate with a cloud or an external system. For example, through the JSON configuration, the SOA adaptor 324 and the SOA gateway 326 may transmit real-time vehicle data (e.g., by collecting CAN data of a vehicle in real time, converting the CAN data into MQTT, and transmitting the MQTT to a cloud), may enable remote diagnosing of the vehicle (e.g., by transmitting engine status data of a vehicle to a cloud server at an HTTP POST request), and may transmit event-based data (e.g., by transmitting through a specific MQTT topic when a vehicle event (e.g., battery warning) occurs). As described above, as the JSON file may be easily read by administrators and users and setting of changes of the JSON file may be simplified, the JSON file may be easier to read and maintain. Furthermore, as the JSON file may be easily adapted to various protocols and systems, the JSON file is flexible for various applications inside and outside the vehicle, thereby enabling integrated operation. Further, the JSON file may also support heterogeneous systems, thereby enabling data exchange between various internal protocols such as CAN, LIN, and Ethernet, and external protocols such as MQTT and HTTP. Moreover, vehicle data may be standardized in the JSON format that may be easily utilized in cloud and IoT environments and may enable easy management of standardized data.

According to an embodiment of the present disclosure, it is described that the SOA adaptor 324 converts the CAN signal inside the vehicle into the service interface format (CAN to Service) to perform routing. However, another embodiment of the present disclosure may include converting the CAN signal into an SOME/IP protocol library (CAN to SOME/IP). A method (e.g., also sometimes referred to herein as “function” or “process”) may be implemented to provide a service by defining data inside the vehicle as a vehicle signal specification (VSS) standardized structure. Such VSS standardized structure may enable the SOA adaptor 324 to converts the data inside the vehicle to various communication protocols and data formats and uses the converted data in SOA environments, or to convert the CAN data into data distribution service (DDS). When the method is implemented, the method may perform routing functions with international standard VSS-based services or with a plurality of protocols. For example, a process of converting VSS in the SOA adaptor may include collecting raw data from a communication network (e.g., CAN, FlexRay, or the like) within the vehicle, mapping the collected data onto a VSS signal tree, converting the VSS signal into a standardized service (API), and transmitting the VSS data through an SOA gateway.

According to an embodiment of the present disclosure, it is described that the SOA gateway 326 collects CAN data of a vehicle in real time, converts the CAN data into MQTT, and transmits the MQTT to a cloud. Data is transmitted to the outside of the vehicle while SOME/IP-based service communication is maintained, and the data transmitted to the outside of the vehicle is identified through an SOME/IP protocol-based controller that is a legacy system. According to another embodiment of the present disclosure, when the SOA gateway 326 supports Automotive API, the SOA gateway 326 may integrate vehicle data with an external service through the Automotive API and/or may support efficient interactions between internal vehicle systems. For example, when the Automotive API of the SOA gateway 326 is applied, a client (e.g., a mobile app or a cloud platform) may perform API request transmission, and the SOA gateway 326 may convert the API request transmitted from the client into a protocol (CAN, SOME/IP, or the like) within the vehicle and may transmit the converted request to the corresponding ECU or sensor. In this way, various external systems (e.g., smartphones or cloud platforms) and vehicle data may be easily integrated with each other.

According to an embodiment of the present disclosure, an SOME/IP protocol stack 328 supports SOA based on an IP-based network, thereby enabling data communication between distributed ECUs in the vehicle. According to another embodiment of the present disclosure, the SOME/IP protocol stack 328 may be implemented through replacement with a data distribution service (DDS) protocol. The DDS protocol may be a key protocol for data-based communication with the autonomous driving controller in an in-vehicle network, and may facilitate real-time data stream management, such as managing and distributing various data flows of autonomous vehicles in real time. As a result, it may be effective in terms of data-based communication and data QOS (ensuring data service quality).

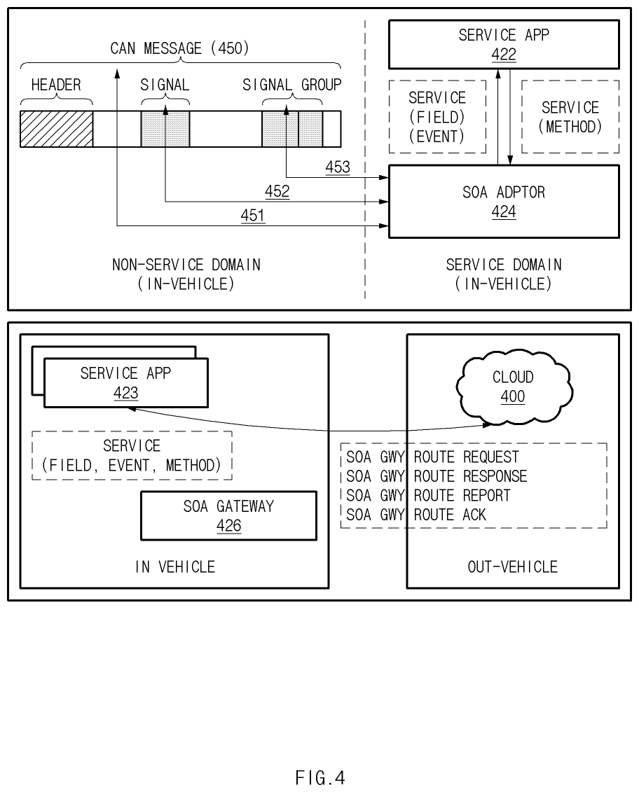

FIG. 4 is a conceptual diagram illustrating a configuration for processing data based on SOA inside a vehicle and outside the vehicle, according to an embodiment of the present disclosure.

Referring to FIG. 4, an SOA adaptor 424 that operates as a bridge between a non-service domain and a service domain within a vehicle, and an SOA gateway 426 that operates as a bridge between an in-vehicle and an out-vehicle are shown. With regard to CAN information 450 of the non-service domain within the vehicle, the SOA adaptor 424 maps a message unit 451, a signal unit 452, and a signal group unit 453 onto field, event, and method (also sometimes referred to as “operation”) forms of the service domain within the vehicle, which are in a service interface format. Moreover, the SOA adaptor 424 assigns a service interface name and ID to each CAN bus. When a service application 422 desires to transmit and receive CAN information of a specific CAN bus, the SOA adaptor 424 supports the service application 422 to allow the service application 422 to find a specific service interface and perform related functions. The SOA adaptor 424 may perform SOME/IP-based service communication according to an SOA service. When the service application 422 is added to the vehicle, the service application 422 may easily receive information provided by the SOA adaptor 424 through a service discovery (SD) process. As described above, in a case of SOA, a system may be designed for service unit, and services may operate independently while also communicating organically with each other.

For example, a communication interface between various service applications (e.g., engine control, temperature control, speed information provision, etc.) inside the vehicle and an external system may be provided. A data format may be standardized by creating a configuration file in a JSON format without changing a service interface, and thus a CAN signal inside the vehicle may be transmitted to the outside of the vehicle. Moreover, in the service discovery (SD) process, the SOA adaptor 424 may register a service (e.g., vehicle speed or temperature status), that is provided by the SOA adaptor 424, in a network. When a new service application is added to the network during service discovery, by providing service ID, method ID, event ID, IP address, and/or port information during registration, the SOA adaptor 424 may find the network to request a list of available services and may return a list of registered services. Moreover, when the service application 422 subscribes to, or calls, a specific service (e.g., providing speed data), the SOA adaptor 424 may be responsible for processing and responding to the corresponding request. According to an embodiment, when a new application or service is added, service registration and discovery may be performed (e.g., automatically performed) without separate configuration, and only the necessary services are requested or subscribed, thus optimizing network resource usage.

The SOA gateway 426 may convert field, event, and method forms, which are service information within a vehicle, into an external protocol such as MQTT or HTTP, thereby enabling communication with the outside of the vehicle. Moreover, when information from a cloud 400 is transmitted to the vehicle, the SOA gateway 426 may receive the information by using an external protocol such as MQTT or HTTP, convert the received information into a service format, and provide the information to a service application 423. The SOA gateway 426 may thus support various communication requests and responses. The main messages used within a route between a client and a server may include REQUEST, RESPONSE, REPORT, and ACK.

According to an embodiment of the present disclosure, the SOA adaptor 424 and the SOA gateway 426 may be connected with each other. Service communication may be possible from the non-service domain and the service domain within the vehicle and an out-vehicle to the cloud 400. For example, CAN data received from a sensor and an ECU inside the vehicle may be generated as a JSON file by the SOA adaptor 424, may be converted to MQTT protocol by the SOA gateway 426, may be provided to the cloud server 400 that is an external system, and may be provided to a user device/IoT device by the service applications 422 and 423.

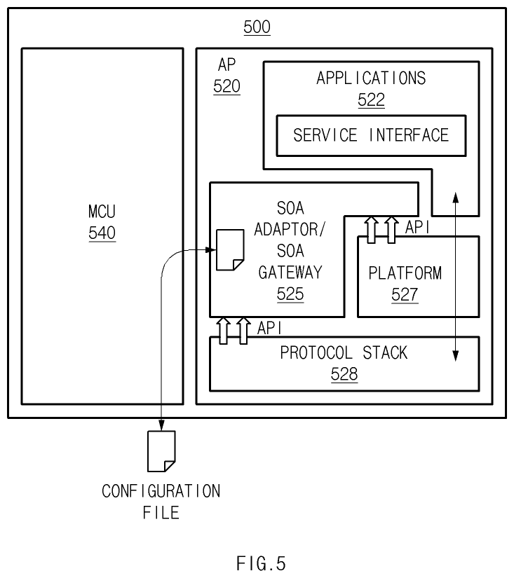

FIG. 5 is a conceptual diagram showing a configuration of data conversion and management based on SOA in a vehicle control apparatus, according to an embodiment of the present disclosure.

Referring to FIG. 5, according to an embodiment of the present disclosure, an SOA adaptor/SOA gateway 525 may be implemented as a single module in the form of middleware. Accordingly, direct communication protocol API may be utilized. The module may operate efficiently based on an SOME/IP protocol 528. Moreover, the SOA adaptor/SOA gateway 525 may easily update software logic by replacing a configuration file. The SW build process may thus be omitted. According to an embodiment of the present disclosure, the SOA adaptor/SOA gateway 525 may operate as a module of a form of middleware. Accordingly, this may not mean the SOA adaptor and the SOA gateway implement an application developed based on a software platform. According to an embodiment of the present disclosure, as the SOA adaptor/SOA gateway 525 operates as a module of a form of single middleware, when a message is sent and received and a new function is added or changed, the module operates by using the new logic simply by replacing only a configuration file without a separate software logic update. Accordingly, an arbitrary connection between a non-service domain and a service domain and a connection to an out-vehicle system may be achieved by the vehicle supporting an SOA service through one module.

An SOA adaptor and an SOA gateway, according to an embodiment of the present disclosure, transmit CAN data and service data within a vehicle to the outside of the vehicle and support out-vehicle data to be used within the vehicle. A single SOA module including the SOA adaptor and the SOA gateway according to an embodiment of the present disclosure may perform service interface communication by converting vehicle data into a file in a JSON format. There is no dependency on a software platform, and thus the corresponding function may be implemented in various controllers using various software platforms. Moreover, when new CAN data inside the vehicle is transmitted to the outside of the vehicle, and new CAN data inside the vehicle is triggered from outside the vehicle, the corresponding function may be performed by simply replacing the file, as the update is possible without including separate software logic. Moreover, when data from outside the vehicle is received by an SOME/IP-based application inside the vehicle, it is possible to transmit and receive data by using an SOA gateway without going through complex processes such as understanding server protocols and understanding the legacy system currently in use.

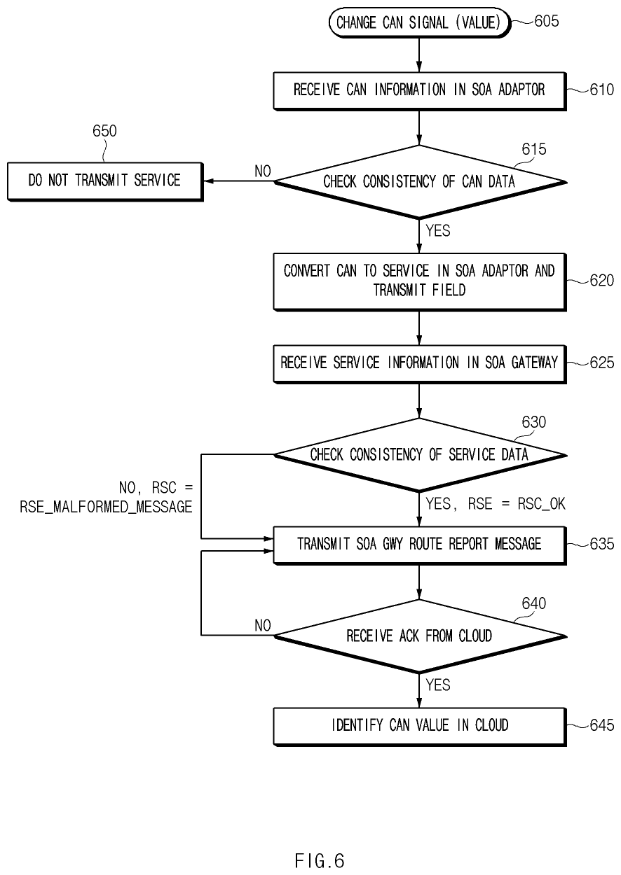

FIG. 6 is a conceptual diagram for describing a process of converting and managing data in a vehicle control apparatus, according to an embodiment of the present disclosure.

Referring to FIG. 6, according to an embodiment of the present disclosure, a process 605 in which CAN data is transmitted to an external cloud when a CAN signal (value) in a vehicle is changed is described. When the CAN signal (value) is changed in a vehicle control apparatus at an end part, the SOA adaptor receives CAN data information. In an operation 615, the consistency of the CAN data is checked. When there is an abnormality (No in the operation 615), the conversion to a service is impossible and the corresponding CAN data is in a service non-transmission state. Accordingly, in an operation 650, the CAN data is not transmitted. On the other hand, when the result of checking the consistency of the CAN data indicates that the consistency check passes (Yes in the operation 615), the SOA adaptor converts the CAN data into data in a service interface format and transmits the data in an operation 620. In an embodiment, the SOA adaptor maps the CAN data into the form of field, event, and method, which is the service interface format, and transmits it to an SOA gateway.

In an operation 625, the SOA gateway receives the field, event, and method, which are in the service interface format. In an operation 630, the SOA gateway performs the consistency check on service data. For example, when the consistency check passes when the consistency of the service data is checked (Yes in the operation 630), an RSC value is mapped to RSC_OK. On the other hand, when the consistency check fails (No in the operation 630), the RSC value is mapped to RSC_MALFORMED_MESSAGE. In an embodiment, mapping the RSC value onto RSC_OK means that there was no error during data processing (Return Status Code: OK), and indicates that the request or the operation is successfully completed. Moreover, the mapping the RSC value onto RSC_MALFORMED_MESSAGE may indicate that a request message was malformed, and may include correcting a problem with the service data and re-transmitting the corrected result.

In an operation 635, the SOA gateway transmits an SOA gateway route report (SOA GWY Route Report) message including the mapped service interface data. When the SOA gateway receives an acknowledge (ACK) from the cloud (Yes in an operation 640), the final CAN value is identified in the cloud in an operation 645. On the other hand, when the SOA gateway does not receive the acknowledge (ACK) from the cloud (No in the operation 640), the SOA gateway performs the operation 635 to re-transmit the SOA gateway route report (SOA GWY Route Report) message to retry logic.

As described above, the consistency check for the CAN data received from sensors and ECUs inside the vehicle is performed, and the SOA adaptor generates a JSON file for the CAN data for which the consistency indicates that a service interface is possible. The JSON file is shared with the SOA gateway, and the SOA gateway determines whether the consistency of the transmitted service interface data is present, converts the JSON file to a MQTT protocol, and transmits the MQTT protocol to a cloud server, which is an external system. It is possible to send and receive data, generated within a vehicle supporting SOA service, to an external cloud through a single SOA module. It is possible to easily communicate with the outside by replacing a configuration file without a separate software logic update.

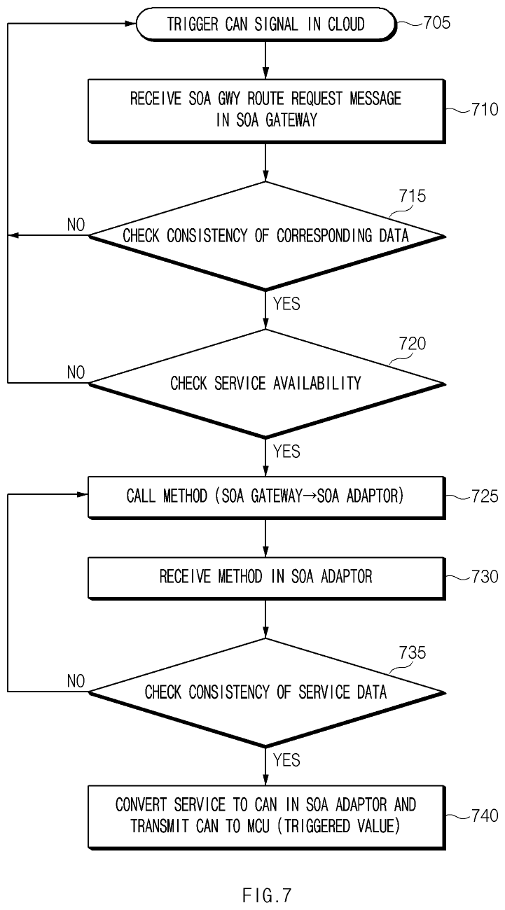

FIG. 7 is a conceptual diagram for describing a process of converting and managing data in a vehicle control apparatus, according to another embodiment of the present disclosure.

Referring to FIG. 7, a signal flow diagram shows that the corresponding value is transmitted to a final CAN bus within a vehicle when a CAN signal is triggered from a cloud outside the vehicle. In an operation 705, the CAN signal is triggered in the cloud. In an operation 710, the SOA gateway receives an SOA gateway route request (SOA GWY Route Request) message in an operation. In an operation 715, the SOA gateway performs a consistency check on the corresponding data. When the consistency check result of the corresponding data indicates that there is an abnormality (No in the operation 715), the result indicating that there is an abnormality in the corresponding data is transmitted to the cloud, and the cloud performs re-triggering on the corresponding CAN signal in the operation 705. On the other hand, when the consistency check result of the corresponding data indicates that there is no abnormality in the consistency (Yes in the operation 715), the SOA gateway checks the service availability of the corresponding service in an operation 720. In an embodiment, checking the service availability in the operation 720 includes checking whether the corresponding service is currently available in the SOA gateway, whether the corresponding service is capable of providing an appropriate response in the SOA gateway, or whether a problem occurs in the service or the corresponding service is not available. Accordingly, checking the service availability in the operation 720 means determining whether the service provided by the cloud is currently available. In an embodiment, when the service is not available, an error message may be returned or an alternative service may be found. When the result of checking the service availability indicates that the service is impossible (No in the operation 720), e.g., when there is an availability abnormality, the SOA gateway reports that there is an error in the cloud in the operation 705.

On the other hand, when result of checking the service availability indicates that the service is possible (Yes in the operation 720, e.g., when there is no availability abnormality, the SOA gateway performs a method call (also sometimes referred herein as “operation call”) to an SOA adaptor in an operation 725.

In an operation 735, the SOA adaptor receives a method and performs a consistency check on the service data. When the consistency check result for the service data indicates that there is an abnormality (No in the operation 735), the SOA adaptor reports to the SOA gateway that there is an abnormality in the received data, and the SOA gateway calls the method again. In an embodiment, the method or operation call of the SOA gateway includes the process of sending a request to a server (e.g., a service provider) through the SOA gateway to execute the function of a specific service requested from the cloud, receiving a response to the request, executing the requested method or operation (or operation ID), and returning result data. In an embodiment, it is possible to check service ID, method ID (or operation ID), request data (Request Payload), and response data (Response Payload). This includes the overall operation of identifying the service ID and the method ID (or the operation ID) and making a request for the identified result to the corresponding server of the cloud requesting the corresponding service. When the consistency check result for the service data indicates that there is no abnormality (Yes in the operation 735), the SOA adaptor converts field, event, method data (also sometimes referred to herein as “operation data”), which is in a service interface format, into CAN data and transmits the corresponding CAN signal to the triggered controller (e.g., MCU) in an operation 740.

According to an embodiment of the present disclosure, a vehicle control apparatus supporting an SOA adaptor and an SOA gateway may receive new CAN data from a cloud outside the vehicle when the new CAN data is defined, and may satisfy the features of the corresponding controller by replacing a configuration file without updating separate software logic (e.g., without OTA or controller build) when the corresponding CAN data is to be triggered outside the vehicle. Furthermore, when a service-based application inside a vehicle desires to receive information (e.g., weather information) outside the vehicle, application logic may be developed by actively utilizing a service interface from an application developer's perspective, by using a middleware-type module through the SOA gateway to process the data. This may be a new feature, and may support various user experiences for vehicle consumers and users. Also, even though the latency of the service may be present, the SOA gateway communicates based on protocol buffers (protobuf), thereby reducing data conversion time. In addition, a vehicle control apparatus that supports the SOA adaptor and the SOA gateway may include a aggregation function and may thereby transmit and receive large amounts of data in a relatively short time. Accordingly, embodiments of the present disclosure may be deployed flexibly when a protocol or a software platform to be bound is changed, because the vehicle control apparatus that supports the SOA adaptor and the SOA gateway and in which there is no platform dependency.

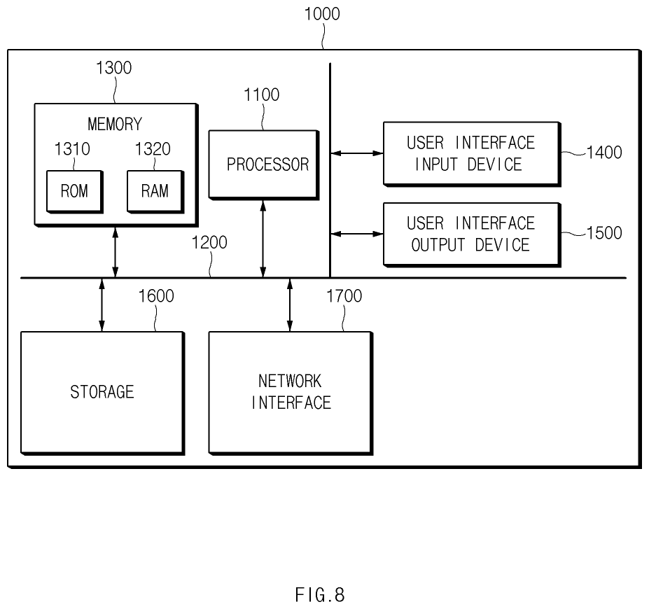

FIG. 8 illustrates a computing system according to an embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (e.g., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one of ordinary skill in the art without departing from the scope and spirit of the present disclosure.

Accordingly, the described embodiments of the present disclosure are intended not to limit but to explain the technical idea of the present disclosure, and the scope and spirit of the present disclosure is not limited by the above embodiments. The scope of protection of the present disclosure should be construed by the appended claims, and all equivalents thereof should be construed as being included within the scope of the present disclosure.

Embodiments of the present technology may send and receive data, generated within a vehicle supporting an SOA service, to an external cloud through a single SOA module. According to embodiments, it is possible to easily communicate with the outside by replacing a configuration file without a separate software logic update.

Moreover, embodiments of the present disclosure may receive new CAN data from a cloud outside the vehicle when the new CAN data is defined in a vehicle control apparatus supporting an SOA adaptor and an SOA gateway, and may satisfy the features of the corresponding controller by generating a configuration file without updating separate software logic (e.g., without OTA or controller build) when the corresponding CAN data is to be triggered outside the vehicle.

Furthermore, when a service-based application in a vehicle desires to receive information (e.g., weather information) from outside the vehicle, application logic may be developed by actively utilizing a service interface from an application developer's perspective, by using a middleware-type module through the SOA gateway to process the data. This may be a new feature, and may support various user experiences for vehicle consumers and users.

Also, even though the latency of the service may be present, the SOA gateway communicates based on protocol buffers (protobuf), thereby reducing data conversion time.

In addition, a vehicle control apparatus that supports the SOA adaptor and the SOA gateway may include a aggregation function, and may thereby transmit and receive large amounts of data in a relatively short time. Accordingly, embodiments of the present disclosure may be deployed flexibly when a protocol or a software platform to be bound is changed, because the vehicle control apparatus, which supports the SOA adaptor and the SOA gateway and in which there is no platform dependency.

Further, a variety of effects directly or indirectly understood through the present disclosure may be provided.

Hereinabove, although the present disclosure was described with reference to several embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A vehicle control apparatus comprising:
a processor configured to receive communication protocol data within a vehicle, convert the communication protocol data within the vehicle into service interface protocol data, and transmit the service interface protocol data to an external vehicle system,
wherein the processor is configured to implement, as a piece of middleware, a service-oriented architecture (SOA) adaptor configured to convert the communication protocol data within the vehicle into the service interface protocol data and an SOA gateway configured to transmit the service interface protocol data converted from the SOA adaptor to an external vehicle cloud network system.

2. The vehicle control apparatus of claim 1, wherein the processor is configured to use controller area network (CAN) communication as a protocol within the vehicle.

3. The vehicle control apparatus of claim 2, wherein the protocol within the vehicle further includes at least one of Ethernet communication, local interconnect network (LIN) communication, FlexRay communication, vehicle signal specification (VSS) communication, or data distribution service (DDS) communication.

4. The vehicle control apparatus of claim 1, wherein the SOA adaptor is configured to:
receive controller area network (CAN) data in the vehicle in real time and convert the CAN data into a JSON configuration file; and
perform communication in units of service defined for an SOA service.

5. The vehicle control apparatus of claim 4, wherein the SOA adaptor is configured to:
identify the CAN data;
perform a consistency check on the identified CAN data; and
map the CAN data into service interface protocol data including a field, an event, and an operation, in response to determining that the CAN data passes the consistency check.

6. The vehicle control apparatus of claim 1, wherein the SOA gateway is configured to:
convert a JSON configuration file received from the SOA adaptor into a message queuing telemetry transport (MQTT) protocol message; and
transmit the MQTT protocol message to the external vehicle cloud network system.

7. The vehicle control apparatus of claim 6, wherein the SOA gateway is configured to:
identify the service interface protocol data received from the SOA adaptor;
perform a consistency check on the service interface protocol data; and
transmit an SOA gateway route report message to the external vehicle cloud network system in response to determining that the service interface protocol data passes the consistency check.

8. The vehicle control apparatus of claim 7, wherein the SOA gateway is configured to:
determine whether an acknowledgment (ACK) for the SOA gateway route report message is received from the external vehicle cloud network system; and
re-transmit the SOA gateway route report message in response to determining that the acknowledgment (ACK) is not received from the external vehicle cloud network system.

9. The vehicle control apparatus of claim 8, wherein the SOA gateway is configured to determine that CAN data within the vehicle is normally received from the external vehicle cloud network system based on determining that the acknowledgment (ACK) is received from the external vehicle cloud network system.

10. The vehicle control apparatus of claim 1, wherein:
the SOA gateway is configured to
receive an SOA gateway route request message including a value for triggering controller area network (CAN) data within the vehicle from the external vehicle cloud network system,
perform a consistency check on the SOA gateway route request message,
check service availability of a service corresponding to a corresponding message in response to determining that the SOA gateway route request message passes the consistency check, and
perform an operation call to the SOA adaptor based on determining that the service is available; and
the SOA adaptor is configured to identify the operation call and transmit the CAN data to a triggered controller corresponding to the operation call,
wherein
the SOA gateway is configured to communicate with the external vehicle cloud network system through at least one of a scalable service-oriented middleware over IP (SOME/IP) protocol, an automotive application programming interface (API), or a DDS protocol, and
the SOA adaptor is configured to perform communication through at least one of Ethernet communication, LIN communication, FlexRay communication, VSS communication, or DDS communication.

11. A vehicle control method comprising:
receiving communication protocol data within a vehicle;
converting, by a service-oriented architecture (SOA) adaptor, the communication protocol data within the vehicle into service interface protocol data; and
transmitting, by an SOA gateway, the service interface protocol data to an external vehicle system,
wherein the SOA adaptor and the SOA gateway are implemented as a piece of middleware.

12. The vehicle control method of claim 11, wherein receiving the communication protocol data within the vehicle includes receiving the communication protocol data using controller area network (CAN) communication.

13. The vehicle control method of claim 11, wherein receiving the communication protocol data within the vehicle includes receiving the communication protocol data using at least one communication of Ethernet communication, LIN communication, FlexRay communication, VSS communication, or DDS communication.

14. The vehicle control method of claim 11, further comprising:
receiving controller area network (CAN) data;
converting, by the SOA adaptor, the CAN data into a JSON configuration file; and
performing, by the SOA adaptor, communication in units of service defined for an SOA service.

15. The vehicle control method of claim 14, further comprising:
identifying, by the SOA adaptor, the CAN data;
performing a consistency check on the received CAN data; and
mapping the CAN data into service interface protocol data including a field, an event, and an operation, in response to determining that the CAN data passes the consistency check.

16. The vehicle control method of claim 11, further comprising:
converting, by the SOA gateway, a received JSON configuration file into a MQTT protocol message; and
transmitting the MQTT protocol message to the external vehicle system.

17. The vehicle control method of claim 16, further comprising:
identifying, by the SOA gateway, received service interface protocol data;
performing a consistency check on the received service interface protocol data; and
transmitting an SOA gateway route report message to the external vehicle system in response to determining that the received service interface protocol data passes the consistency check.

18. The vehicle control method of claim 17, further comprising:
determining, by the SOA gateway, whether an acknowledgment (ACK) for the SOA gateway route report message is received from the external vehicle system; and
re-transmitting the SOA gateway route report message in response to determining that the acknowledgment (ACK) is not received from the external vehicle system.

19. The vehicle control method of claim 18, further comprising determining, by the SOA gateway, that CAN data within the vehicle is normally received from the external vehicle system based on determining that the acknowledgment (ACK) is received from the external vehicle system.

20. The vehicle control method of claim 11, further comprising:
receiving, by the SOA gateway, an SOA gateway route request message including a value for triggering CAN data within the vehicle from the external vehicle system;
performing a consistency check on the SOA gateway route request message;
checking service availability of a service corresponding to a corresponding message based on determining that the SOA gateway route request message passes the consistency check;
performing an operation call based on determining that the service is available;
identifying, by the SOA adaptor, the operation call; and
transmitting the CAN data to a triggered controller corresponding to the operation call,
wherein the method further includes
communicating, by the SOA gateway, with the external vehicle system through at least one of a SOME/IP protocol, an automotive API, or a DDS protocol, and
performing, by the SOA adaptor, communication through at least one of Ethernet communication, LIN communication, FlexRay communication, VSS communication, or DDS communication.
